(19) United States
(12) Patent Application Publication
(10) Pub. No.: US 2014/0228536 A1
(43) Pub. Date: Aug. 14, 2014

(54) MANUFACTURING POLYESTERS

(71) Applicant: STICHTING PUBLIC PRIVATE PARTNERSHIP INSTITUTE FOR SUSTAINABLE PROCESS TECHNOLOGY, Amersfoort (NL)

(72) Inventors: André Banier De Haan, Eindhoven (NL); Anton Alexandru Kiss, Deventer (NL); Maarten Leonard Oudshoorn, Zwolle (NL); Mayankkumar Rameshchandra Shah, Eindhoven (NL)

(73) Assignee: AKZO NOBEL COATINGS INTERNATIONAL B.V., ARNHEM (NL)

(21) Appl. No.: 14/346,023

(22) PCT Filed: Sep. 28, 2012
(86) PCT No.: PCT/NL2012/050679

§ 371 Date: Mar. 20, 2014

(30) Foreign Application Priority Data
Sep. 28, 2011 (EP) 11183159.0

(51) Int. Cl. C08G 63/78

(52) U.S. Cl. CPC C08G 63/78
USPC 528/306

(57) ABSTRACT

The present invention provides a continuous process of manufacturing polyester comprising introducing a polyol (7) and a polycarboxylic acid (9) into a pre-reactor (1) and allowing the polyol and the polycarboxylic acid to react to obtain a pre-polymer mixture including a polyfunctional ester; introducing the pre-polymer mixture (10) into the inlet section (13) of a distillation column (5) having a stripping section (15) and a rectifying section (16); supplying stripping gas (20) into the bottom of the distillation column (5); allowing the polyfunctional ester to polymerize in the stripping section (15) so as to form polyester and a gaseous mixture including water and unreacted reactants; removing polyester (30) from the distillation column (15); and allowing the gaseous mixture to pass through the rectifying section (16), removing from the top of the distillation column (5) a gaseous phase (35), at least partially condensing the gaseous phase and returning (46) part of the condensed gaseous phase as reflux into the distillation column (5).

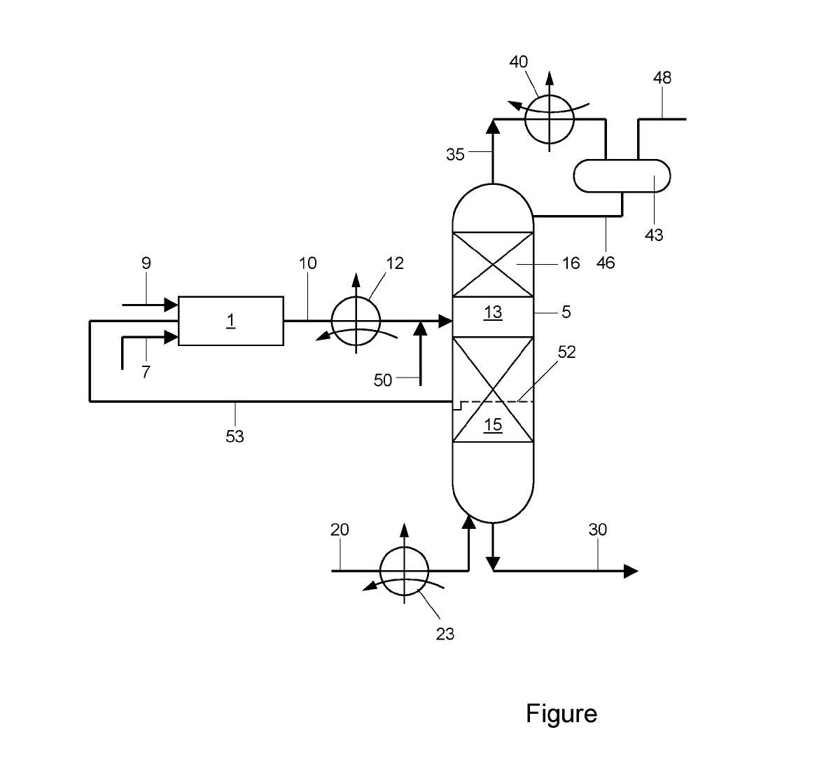

### FIELD OF THE INVENTION

The present invention relates to manufacturing polyesters using reactive distillation.

In general polyesters are formed by condensation of a polyol and a polycarboxylic acid or an anhydride of a polycarboxylic acid, wherein a polycarboxylic acid is an acid containing two or more carboxyl groups in the molecule.

In general two distinct reactions can take place to obtain polyester. At first a monoester is formed, and secondly the monoester is polymerized to obtain polyester along with water by-product.

In case a polycarboxylic acid is used, the first reaction comprises reacting at least one of the carboxyl groups with a polyol to form a monoester along with water as a by-product.

In case an anhydride of a polycarboxylic acid is used, the first reaction comprises reacting at least one of the carboxyl groups of the anhydride with a polyol to form a monoester. No water is formed.

In case a cyclic anhydride of a polycarboxylic acid is used, the first reaction is a ring-opening reaction, wherein the ring of the anhydride is opened in order to form a monoester.

Saturated polyester is obtained when the polycarboxylic acid or its anhydride is ethylenically saturated, and an ethylenically unsaturated polyester is obtained when the polycarboxylic acid or its anhydride is ethylenically unsaturated.

Polyesters are generally polycondensation products of polyalcohols and polycarboxylic acids.

Referring next to the polyester, useful polyesters generally comprise the esterification products of polycarboxylic acids or ester-forming derivatives thereof with polyols. When dicarboxylic acids and diols are employed as starting materials, linear polyester polymers are obtained. If so desired, varying degrees of branching in the polyester polymers can be obtained by using a suitable amount of higher functional starting materials, for example tri- or tetrafunctional materials, such as trimellitic anhydride, trimethylol propane, glycerol, ditrimethylol propane, pentaerythritol, or dimethylol propionic acid. If so desired, also small amounts of monofunctional starting materials can be used to control the molecular weight of the polyester polymer.

Examples of polycarboxylic acids which may be used in the preparation of a polyester include maleic acid, fumaric acid, itaconic acid, isophthalic acid, terephthalic acid, hexahydroterephthalic acid, 2,6-naphthalenedicarboxylic acid, 4,4′-oxybisbenzoic acid, 3,6-dichlorophthalic acid, tetrachlorophthalic acid, tetrahydrophthalic acid, hexahydroterephthalic acid, hexachloroendomethylenetetrahydrophthalic acid, endomethylenetetrahydrophthalic acid, phenol stearic acid, phthalic acid, azelaic acid, sebacic acid, glutaric acid, pimelic acid, subercic acid, decanedicarboxylic acid, adipic acid, succinic acid and trimellitic acid. These illustrative acids can be used in their acid form, or where available, in the form of their anhydrides or lower alkyl esters. Mixtures of acids can also be used. In addition hydroxycarboxylic acids and lactones can be used. Examples include hydroxypivalic acid and ε-caprolactone.

Polyalcohols, in particular diols, can be reacted with the carboxylic acids or their analogues as described above to prepare the polyester. Examples of polyalcohols include aliphatic diols, for example, ethylene glycol, propane-1,2-diol, propane-1,3-diol, butane-1,2-diol, butane-1,4-diol, butane-1,3-diol, 2,2-dimethylpropane-1,3-diol (neopentyl glycol), hexane-2,5-diol, hexane-1,6-diol, 2,2-bis-(4-hydroxycyclohexyl)-propane (hydrogenated bisphenol-A), 1,3-dimethylolcyclohexane, 1,4-dimethylolcyclohexane, diethylene glycol, dipropylene glycol and 2,2-bis[4-(2-hydroxyethoxy)-phenyl]propane, the hydroxypivalic ester of neopentylglycol and 4,8-bis(hydroxymethyl)tricyclo[5,2,1,0]decane (=tricyclodecane dimethylol) and 2,3-butenediol.

Unless specifically mentioned, we will use in the specification and in the claims the term ‘polycarboxylic acid’ to refer to both a polycarboxylic acid and an anhydride of a polycarboxylic acid. In addition the word ‘gas’ is used to refer to both a gas and a vapour, and the adjective ‘gaseous’ is used to refer to both gaseous and vaporous.

### BACKGROUND OF THE INVENTION

In the article M. Shah et al, Process modeling for the synthesis of unsaturated polyester, Polymer engineering and science 2011 (published online in Wiley Online Library, wileyonlinelibrary.com) reference is made to modelling an industrial process of manufacturing unsaturated polyester. The known process is a batch process that comprises the steps of:
a. filling a heated reactor vessel with a sufficient amount of a polyol (propylene glycol) and an anhydride of a polycarboxylic acid (maleic anhydride), allowing the polyol and the anhydride of the polycarboxylic acid to react to obtain polyester in liquid form and a gaseous stream of water and unreacted reactants;
b. allowing the gaseous stream to enter into the bottom of a distillation column, removing from the top of the distillation column a gaseous phase, at least partially condensing the gaseous phase and returning part of the condensed gaseous phase as reflux into the top of the distillation column; and
c. removing polyester from the bottom of the reactor vessel when the reaction is sufficiently complete.

In the article M. Shah et al, Development of a model for the synthesis of unsaturated polyester by reactive distillation, Distillation Absorption 2010, is described a continuous process of manufacturing polyester, which process comprises the steps of:
a. feeding to the top of a reactive distillation column a heated liquid anhydride of a polycarboxylic acid (maleic anhydride) and to the bottom of the reactive distillation column a heated gaseous polyol (propylene glycol);
b. allowing the anhydride of the polycarboxylic acid and the polyol to react to obtain polyester in liquid form;
c. removing polyester from the bottom of the reactive distillation column, and removing from the top of the reactive distillation column a gaseous stream of water and unreacted reactants.

In the specification and in the claims the expression ‘polyfunctional ester’ is used to refer to an ester that has two or more reactive groups, in particular two or more reactive groups capable of participating in a polycondensation reaction to form an ester, more in particular two or more carboxylic acid (anhydride) functionalities.

### SUMMARY OF THE INVENTION

It is an object of the present invention to improve the continuous process, and more in particular it is an object of the present invention to improve the flexibility of the continuous process.

To this end the continuous process of manufacturing polyester according to the present invention comprises the steps of:
a. introducing a polyol and a polycarboxylic acid or an anhydride of a polycarboxylic acid into a pre-reactor and allowing the polyol and the polycarboxylic acid or the anhydride of the polycarboxylic acid to react to obtain a pre-polymer mixture including a polyfunctional ester; and
b. introducing the pre-polymer mixture into the inlet section of a distillation column having a stripping section below the inlet section and a rectifying section above the inlet section;
c. introducing stripping gas into the bottom of the distillation column;
d. allowing the polyfunctional ester to polymerize in the stripping section so as to form polyester and a gaseous mixture including water and unreacted reactants;
e. removing polyester from the bottom of the distillation column; and
f. allowing the gaseous mixture to pass through the rectifying section, removing from the top of the distillation column a gaseous phase, at least partially condensing the gaseous phase and returning at least part of the condensed gaseous phase as reflux into the top of the distillation column.

By splitting the process of manufacturing into two steps, one carried out in the pre-reactor and the second in the distillation column, the conditions, pressure, temperature and catalysts, can be optimized separately for manufacturing the polyfunctional ester pre-polymer mixture and for manufacturing subsequently polyester itself. This has a beneficial effect on the quality of the obtained polyester.

In addition it could be beneficial to introduce a sub-stoichiometric amount of polyol into the pre-reactor and to introduce the remainder as heated stripping gas into the bottom of the distillation column. By sub-stoichiometric amount of polyol it is meant that the ratio of the molar amount of hydroxyl groups provided by the starting materials to the molar amount of carboxylic acid groups (or ester-forming derivatives thereof) provided by the starting materials is less than 1, for example between 0.05 and 1.0 of the stoichiometric amount of polyol. The part of polyol fed to the pre-reactor allows reacting polycarboxylic acid or anhydride while heating and mixing. Moreover, it also allows solubilizing solid polycarboxylic acid or anhydride in polyol and thereby heating is improved and the heating time is reduced. The remaining amount of polyol fed to the stripping section as a vapour or gas allows stripping out produced water from the reaction medium. Thereby, it increases the reaction rate. Moreover, the heated polyol vapour fed to the stripping section provides the required heat into the stripping section for reaction and separation.

Furthermore, a numerical example has shown that with the process according to the present invention, the liquid hold-up in the stripping section is much smaller than the liquid hold-up in the distillation column in the known process. For this reason the process of the present invention is particularly suitable for manufacturing relatively small amounts of polyester of different grades.

For the sake of completeness we refer to International patent application publication No. WO 03/046 044. This publication discloses a process of manufacturing a pre-polymer, wherein a partly esterified oligomer is introduced in a pre-polycondensation reactor. The gaseous condensation products are removed from the pre-polycondensation reactor by means of a stripping gas, and the pre-polymer is supplied to a further process step for polycondensation. The stripped gaseous products are condensed and the condensate is further treated in a rectifying column to obtain an alcohol-rich stream that is used as a feed for the process and an aqueous stream that is used as stripping gas. This publication does not suggest, for example, allowing the polyfunctional ester to polymerize in the stripping section of a distillation column. By the integration of equipment in accordance with the present invention less equipment is required. Therefore the publication is not relevant to the present invention.

USA patent specifications No. 3 127 377 and No. 3 109 833 disclose a batch process for manufacturing polyesters. These publications are not relevant to the present invention, because the present invention is relating to a continuous process.

### DETAILED DESCRIPTION OF THE INVENTION

The invention will now be described by way of example in more detail with reference to the accompanying Figure showing schematically a plant for manufacturing polyester with the continuous process according to the present invention.

The plant comprises a pre-reactor 1 and a reactive distillation column 5. In the process according to the present invention, a polyol and a polycarboxylic acid are continuously introduced into the pre-reactor through conduits 7 and 9, respectively. The reactants, polyol and polycarboxylic acid are introduced into the pre-reactor 1 at such a pressure and temperature that they react so as to obtain a pre-polymer mixture including a polyfunctional ester. Pumps and heaters that may be required to ensure that the reactants are at the required pressure and temperature conditions are not shown. The reaction can be catalysed by a suitable catalyst, which can be a homogeneous catalyst, supplied with the reactants, or a heterogeneous catalyst which is present in the pre-reactor 1 on internals (not shown). Pressures in the pre-reactor 1 are suitably in the range of from 0.1 to 5 MPa (absolute) and temperatures are suitably in the range of from 150 to 300° C. As catalyst in the pre-reactor 1 the known catalyst for polyester synthesis can be used, such as for instance titanium based catalyst, antimony based catalysts, tin based catalyst, and so on, in their various forms like for instance as alkoxylates or as carboxylates and so on. The pre-reactor 1 allows reacting while heating and mixing the reactants, which will result in a reduction of the overall production time.

The pre-polymer mixture comprises the formed polyfunctional ester and unreacted reactants. Suitably the pre-polymer mixture has an acid value of more than 50 mg/g, wherein the acid value is a measure of the amount of free acid equal to the number of milligrams of potassium hydroxide needed to neutralize the acid.

The pre-polymer mixture is continuously withdrawn from the pre-reactor 1 through conduit 10.

The pre-polymer mixture is supplied through conduit 10 to the inlet section 13 of the distillation column 5. Conduit 10 is provided with a heater 12 so as to heat the pre-polymer mixture to a suitable temperature.

The distillation column 5 has a stripping section 15 below the inlet section 13 and a rectifying section 16 above the inlet section 13. The pre-polymer mixture is introduced into the inlet section 13 of the distillation column 5 between the stripping section 15 and the rectifying section 16. For the sake of clarity we do not show a liquid distributor that will be arranged in the inlet section 13.

In the stripping section 15 of the distillation column 13, the polyfunctional ester is allowed to polymerize further in order to form the desired polyester. Suitably the polyester has an acid value less than 50 mg/g. In the stripping section 15 not only polyester product in liquid form is obtained, but also a gaseous mixture containing water and unreacted reactants.

The sections 15 and 16 are provided with internals; suitably the internals are structured packing. Polymerization of the polyfunctional ester can be catalysed by means of a homogeneous catalyst. Alternatively, a heterogeneous catalyst is arranged in at least part of the stripping section 15. In this case, the volume of the section of the stripping section 15 provided with catalyst is suitably between 0.20 and 1.0 of the volume of the stripping section 15.

As catalyst in the stripping section 15, the known catalyst for polyester synthesis can be used, such as for instance titanium based catalyst, antimony based catalysts, tin based catalyst, and so on, in their various forms like for instance as alkoxylates or as carboxylates and so on.

Pressures in the stripping section 15 are suitably in the range of from 10⁻⁵ to 0.2 MPA (absolute) and temperatures are suitably in the range of from 200 to 300° C.

Heated stripping gas is supplied into the bottom of the distillation column 5 through conduit 20 provided with a heater 23. The heated stripping gas is supplied to strip the gaseous mixture from the polyester in the stripping section 15, and to supply heat needed to allow the polymerisation reaction.

Polyester in liquid form is removed as a product stream from the bottom of the distillation column 5 through conduit 30, and passed to a storage tank (not shown). The residence time of the polyester in the stripping section is suitably between 0.5 and 2 hours. In case the stripping section is provided with structured packing, the flowrates of liquid and gas through the stripping section 15 are so selected that the stripping section 15 is operated at conditions in the range of 30 to 100% flooding, and suitably at conditions in the range of from 80% to 90% of flooding. Or alternatively the stripping section is so operated that the liquid phase is the continuous phase with a dispersed gaseous phase. Equipment to control the flowrates has not been shown.

The gases stripped from the polyester and from the pre-polymer mixture supplied through conduit 10 rise as a gaseous mixture through the rectifying section 16, where the gaseous mixture is rectified. Rectified gas is removed from the top of the distillation column 5 through conduit 35 provided with a condenser 40 so as to partially condense the rectified gas. The partially condensed gas is supplied to a separator vessel 43 from which a liquid stream is removed through conduit 46 and a gaseous stream through conduit 48. The liquid stream is returned through conduit 46 as reflux to the top of the distillation column 5 in order to wash the rising gases in the rectifying section 16. The gaseous stream is removed through conduit 48 to a treating plant for removing valuable components from the gaseous stream or for safely disposing the gaseous stream.

Continuing the reaction in the distillation column 5 allows reaction and separation to be carried out in one unit. This reduces the size of the plant, production time and energy.

In a suitable embodiment additional polycarboxylic acid or anhydride of polycarboxylic acid can be supplied through conduit 50 to the inlet section 13. Alternatively the additional polycarboxylic acid or anhydride of polycarboxylic acid can be supplied to any stage in the stripping section 15. This feature allows a smaller pre-reactor. In addition the acid value of the end product can be adjusted, and so the consistency in the product quality can be improved.

In a further suitable embodiment, a recycle is introduced in order to increase the residence time of the reactants. To this end part of the reactants in the stripping section 15 is removed from the stripping section 15 using a draw-off tray 52. Through conduit 53 the removed reactants are introduced into the pre-reactor 1. The amount of reactants that is supplied to the pre-reactor 1 per unit of time is suitably in the range of from 10 to 30% of the amount of reactants passing per unit of time through the stripping section 15.

As explained, polyol and polycarboxylic acid react in the pre-reactor 1 to form the pre-polymer mixture including a polyfunctional ester, which is allowed to polymerize in order to form polyester in the stripping section 15 of the distillation column 5. Stripping gas is used to strip the water-containing gaseous mixture obtained in the polymerisation of the pre-polymer. The stripping gas supplied through conduit 20 can be an inert gas. However suitably, the stripping gas is gasified polyol. Introducing gasified polyol into the stripping section 15 allows introducing a sub-stoichiometric amount of polyol into the pre-reactor 1, and introducing the remainder of the polyol as heated stripping gas through conduit 20 into the bottom of the distillation column 5 below the stripping section 15. The amount of polyol supplied to the pre-reactor 1 is suitably between 0.05 and 1.0 of the stoichiometric amount of polyol. The overall amount of polyol supplied to the pre-reactor 1 and the distillation column 5 is suitably in the range of from 1.0 to 2.0 times the overall stoichiometric amount.

The advantage of the present invention will now be demonstrated by means of the below numerical examples.

In the first example, not according to the invention, maleic anhydride and propylene glycol are fed to a reactive distillation column having a stripping section having 20 theoretical trays, and the volume of the stripping section is 25.0 m³. Maleic anhydride feed (liquid) is fed into the top of the reactive distillation column at a flow rate of 7000 kg/hr and at a temperature of 185° C.; propylene glycol feed (gas) is fed into the bottom of the reactive distillation column at a flow rate of 6544 kg/hr and at a temperature of 300° C. The anhydride to glycol molar feed ratio is 1:1.2, which corresponds to 1.2 times the stoichiometric ratio. The liquid hold-up in the stripping section is 16.2 m³. Withdrawn from the bottom of the reactive distillation column is 11415 kg/hr polyester with an acid value of 25 mg/g and at a temperature of 272° C. Withdrawn from the top of the distillation column is a gas, part of the gas is condensed and returned as reflux into the top of the distillation column at a flowrate of 363 kg/hr and a temperature of 99° C.

In the second example, according to the present invention, maleic anhydride and propylene glycol are fed to a pre-reactor 1 having a volume of 1.3 m³. Maleic anhydride feed (liquid) is fed through conduit 9 to the pre-reactor at a flowrate of 5540 kg/hr and at a temperature of 55° C., and propylene glycol feed (liquid) is fed through conduit 7 at a flowrate of 4300 kg/hr and at a temperature of 55° C. A pre-polymer mixture is withdrawn from the pre-reactor 1 through conduit 10 at a flowrate of 9840 kg/hr, the pre-polymer mixture has an acid value of 321 mg/g. The pre-polymer mixture is introduced at a temperature of 250° C. into the inlet section 13 of a reactive distillation column 5 having a rectifying section 16 having 20 theoretical stages and a volume of 12.6 m³ and a stripping section 15 of 9 theoretical stages and a volume of 0.57 m³. Gaseous propylene glycol is introduced into the bottom of the distillation column through conduit 20 at a rate of 2815 kg/hr and at a temperature of 255° C. This results in an overall acid to glycol molar feed ratio of 1:1.7 (overall mass balance: column 5 and pre-reactor 1), which corresponds to 1.7 times the stoichiometric ratio. Withdrawn from the bottom of the distillation column 5 though conduit 30 is 11415 kg/hr polyester with an acid value of 25 mg/g and at a temperature of 257° C. Withdrawn from the top of the distillation column 5 is a rectified gas through conduit 35, part of the gas is condensed and returned as reflux into the top of the distillation column 5 at a flowrate of 464 kg/hr and a temperature of 99° C.

The above examples demonstrate that the liquid hold-up in the stripping section of the distillation column is reduced by 50% when applying the process according to the present invention. Because the liquid hold-up is so much smaller, the distillation column can be emptied more rapidly to allow manufacturing a different grade of polyester. For this reason the process according to the present invention is particularly suitable for manufacturing relatively small amounts of polyester of different grades.

1. A continuous process of manufacturing polyester comprising the steps of:
a. introducing a polyol and a polycarboxylic acid or an anhydride of a polycarboxylic acid into a pre-reactor and allowing the polyol and the polycarboxylic acid or the anhydride of the polycarboxylic acid to react to obtain a pre-polymer mixture including a polyfunctional ester; and
b. introducing the pre-polymer mixture into an inlet section of a distillation column having a stripping section below the inlet section and a rectifying section above the inlet section;
c. supplying a stripping gas into the bottom of the distillation column;
d. allowing the polyfunctional ester to polymerize in the stripping section so as to form a polyester and a gaseous mixture including water and unreacted reactants;
e. removing the polyester from the bottom of the distillation column; and
f. allowing the gaseous mixture to pass through the rectifying section, removing from the top of the distillation column a gaseous phase, at least partially condensing the gaseous phase and returning at least part of the condensed gaseous phase as reflux into the top of the distillation column.

2. The continuous process according to claim 1, wherein the pressure in the pre-reactor is in the range of from 0.1 to 5 MPa (absolute) and wherein the temperature is in the range of from 150 to 300° C.

3. The continuous process according to claim 1, wherein the pressure in the stripping section is in the range of from 10⁻⁵ to 0.2 MPa (absolute) and wherein the temperature is in the range of from 200 to 300° C.

4. The continuous process according to claim 1, further comprising supplying additional polycarboxylic acid or anhydride of polycarboxylic acid to the inlet section of the distillation column.

5. The continuous process according to claim 1, further comprising supplying additional polycarboxylic acid or anhydride of polycarboxylic acid to any stage of the stripping section.

6. The continuous process according to claim 1, further comprising removing part of the reactants from the stripping section, and supplying the removed reactants into the pre-reactor.

7. The continuous process according to claim 1, wherein a sub-stoichiometric amount of the polyol is introduced into the pre-reactor and wherein the remainder as is introduced as heated stripping gas into the bottom of the distillation column.

8. The continuous process according to claim 7, wherein the amount of polyol introduced into the pre-reactor is between 0.05 and 1.0 of the stoichiometric amount of polyol.

9. The continuous process according to claim 2, wherein the pressure in the stripping section is in the range of from 10⁻⁵ to 0.2 MPa (absolute) and wherein the temperature is in the range of from 200 to 300° C.

10. The continuous process according to claim 2, further comprising supplying additional polycarboxylic acid or anhydride of polycarboxylic acid to the inlet section of the distillation column.

11. The continuous process according to claim 3, further comprising supplying additional polycarboxylic acid or anhydride of polycarboxylic acid to the inlet section of the distillation column.

12. The continuous process according to claim 2, further comprising supplying additional polycarboxylic acid or anhydride of polycarboxylic acid to any stage of the stripping section.

13. The continuous process according to claim 3, further comprising supplying additional polycarboxylic acid or anhydride of polycarboxylic acid to any stage of the stripping section.

14. The continuous process according to claim 4, further comprising removing part of the reactants from the stripping section, and supplying the removed reactants into the pre-reactor.

15. The continuous process according to claim 5, further comprising removing part of the reactants from the stripping section, and supplying the removed reactants into the pre-reactor.

16. The continuous process according to claim 9, further comprising removing part of the reactants from the stripping section, and supplying the removed reactants into the pre-reactor.

17. The continuous process according to claim 13, further comprising removing part of the reactants from the stripping section, and supplying the removed reactants into the pre-reactor.

18. The continuous process according to claim 3, wherein a sub-stoichiometric amount of the polyol is introduced into the pre-reactor and wherein the remainder is introduced as heated stripping gas into the bottom of the distillation column.

19. The continuous process according to claim 5, wherein a sub-stoichiometric amount of the polyol is introduced into the pre-reactor and wherein the remainder is introduced as heated stripping gas into the bottom of the distillation column.

20. The continuous process according to claim 6, wherein a sub-stoichiometric amount of the polyol is introduced into the pre-reactor and wherein the remainder is introduced as heated stripping gas into the bottom of the distillation column.
